(19) United States
(12) Patent Application Publication
(10) Pub. No.: US 2025/0193756 A1
(43) Pub. Date: Jun. 12, 2025

(54) SEAMLESS ROAMING IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 18/959,374

(22) Filed: Nov. 25, 2024

Related U.S. Application Data
(60) Provisional application No. 63/607,830, filed on Dec. 8, 2023.
(60) Provisional application No. 63/609,199, filed on Dec. 12, 2023.
(60) Provisional application No. 63/656,924, filed on Jun. 6, 2024.
(60) Provisional application No. 63/690,101, filed on Sep. 3, 2024.

(51) Int. Cl. H04W 36/18; H04W 36/00; H04W 36/24; H04W 36/30

(52) U.S. Cl. CPC H04W 36/18; H04W 36/0061; H04W 36/249; H04W 36/302

(57) ABSTRACT

A station (STA) in a wireless network, comprising a memory and a processor coupled to the memory, the processor configured to: transmit, to a first access point (AP) via a first link, a first frame that requests a switch from the first AP to a second AP, wherein the first AP and the second AP form a seamless roaming domain and the first link is established between the STA and the first AP; receive, from the first AP, a second frame that includes information for communicating with the second AP, wherein the second link is established between the STA and the second AP; and switch to the second AP using the information for communicating with the second AP.

### CROSS-REFERENCE TO RELATED APPLICATION(S)

This application claims the benefit of priority from U.S. Provisional Application No. 63/607,830, entitled “Link Indication Procedures for Next Generation WLANS” filed Dec. 8, 2023; U.S. Provisional Application No. 63/609,199, entitled “Transition Procedures for Next Generation WLANS” filed Dec. 12, 2023; U.S. Provisional Application No. 63/656,924 entitled “Transition Procedures for Next Generation WLANS” filed Jun. 6, 2024; and U.S. Provisional Application No. 63/690,101 entitled “Transition Procedures for Next Generation WLANS” filed Sep. 3, 2024, all of which are incorporated herein by reference in their entireties.

### TECHNICAL FIELD

This disclosure relates generally to a wireless communication system, and more particularly to, for example, but not limited to, seamless roaming in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising: a memory; and a processor coupled to the memory. The processor is configured to transmit, to a first access point (AP) via a first link, a first frame that requests a switch from the first AP to a second AP, wherein the first AP and the second AP form a seamless roaming domain and the first link is established between the STA and the first AP. The processor is configured to receive, from the first AP via the first link or the second AP via a second link, a second frame in response to the first frame that includes information for communicating with the second AP, wherein the second link is established between the STA and the second AP. The processor is configured to switch to the second AP using the information for communicating with the second AP.

In some embodiments, the second frame includes at least one of identifier information for the second AP or timing information that indicates a time during which the switch to the second AP is to occur.

In some embodiments, the processor is further configured to receive, from the first AP, a frame that includes at least one of i) a recommendation that the STA switch to a different AP from one or more candidate APs that includes the second AP, ii) a reason for the recommendation, or iii) timing information that indicates a time during which the switch to the different AP is to occur.

In some embodiments, the reason for the recommendation is a low quality link due to at least one of a low received signal strength indicator (RSSI) or a high packet loss rate of the STA.

In some embodiments, the processor is further configured to transmit, to the first AP, a request frame that includes a first set of APs, including the second AP, that the STA prefers to switch to.

In some embodiments, the processor is further configured to receive, from the first AP in response to the request frame, a response frame that includes a second set of APs, including the second AP, that are prepared for the STA to switch to.

In some embodiments, the processor is further configured to delete the first link between the STA and the first AP in response to receiving the second frame.

In some embodiments, the processor is further configured to maintain the first link between the STA and the first AP in response to receiving the second frame.

In some embodiments, the first AP and the second AP are connected such that the first AP and the second AP coordinate with each other to allow roaming without association or reassociation with the STA.

One aspect of the present disclosure provides a first access point (AP) in a wireless network, comprising: a memory; and a processor coupled to the memory. The processor is configured to receive, from a station (STA) via a first link, a first frame that requests a switch from the first AP to a second AP, wherein the first AP and the second AP form a seamless roaming domain and the first link is established between the STA and the first AP. The processor is configured to transmit, to the STA via the first link, a second frame in response to the first frame that includes information for communicating with the second AP, wherein the second link is established between the STA and the second AP.

In some embodiments, the second frame includes at least one of identifier information for the second AP or timing information that indicates a time during which the switch to the second AP is to occur.

In some embodiments, the processor is further configured to: transmit, to the STA, a frame that includes at least one of i) a recommendation that the STA switch to a different AP from one or more candidate APs that includes the second AP, ii) a reason for the recommendation, or iii) timing information that indicates a time during which the switch to the different AP is to occur.

In some embodiments, the reason for the recommendation is a low quality link due to at least one of a low received signal strength indicator (RSSI) or a packet loss rate of the STA.

In some embodiments, the processor is further configured to receive, from the STA, a request frame that includes a first set of APs, including the second AP, that the STA prefers to switch to.

In some embodiments, the processor is further configured to transmit, to the STA in response to the request frame, a response frame that includes a second set of APs, including the second AP, that are prepared for the STA to switch to.

In some embodiments, the processor is further configured to delete the first link between the STA and the first AP after transmitting the second frame.

In some embodiments, the processor is further configured to maintain the first link between the STA and the first AP after transmitting the second frame.

In some embodiments, the first AP and the second AP are connected such that the first AP and the second AP coordinate with each other to allow roaming without association or reassociation with the STA.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates a logical AP MLD in accordance with an embodiment.

FIG. 6 illustrates forming a non-collocated AP MLD (NCAP) in accordance with an embodiment.

FIG. 7 illustrates an AP forming a seamless mobility domain (SMD) in accordance with an embodiment.

FIG. 8 illustrates an example SMD call flow without a preparation message exchange in accordance with an embodiment.

FIG. 9 illustrates an example communication of a response message via a current AP in accordance with an embodiment.

FIG. 10 illustrates an example communication of a response message via a target AP in accordance with an embodiment.

FIG. 11 illustrates an example communication on a wired network in accordance with an embodiment.

FIG. 12 illustrates an example link ID info field in accordance with an embodiment.

FIG. 13 illustrates a link ID info field format in accordance with an embodiment.

FIG. 14 illustrates an example element format in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

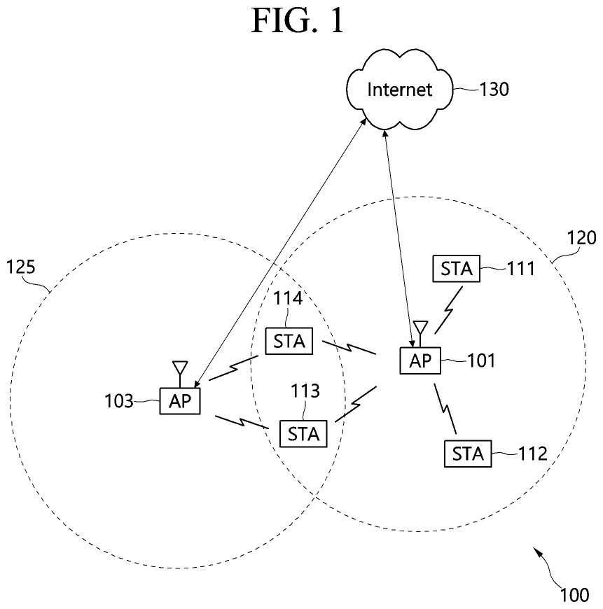

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

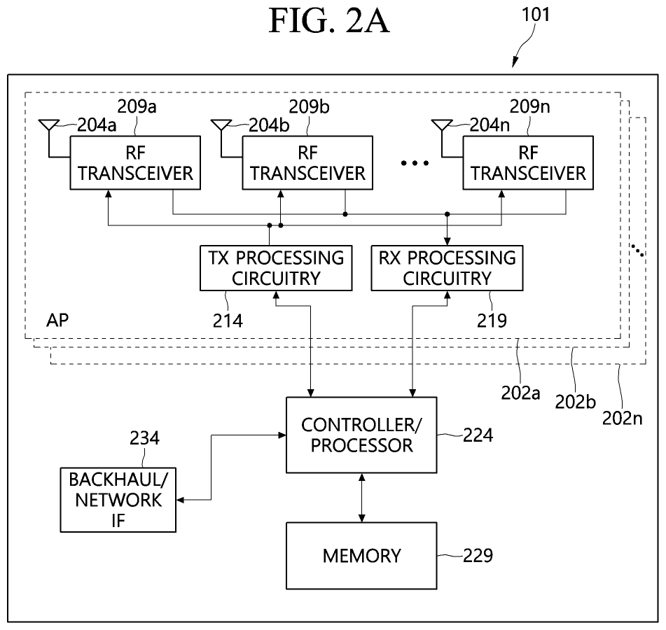

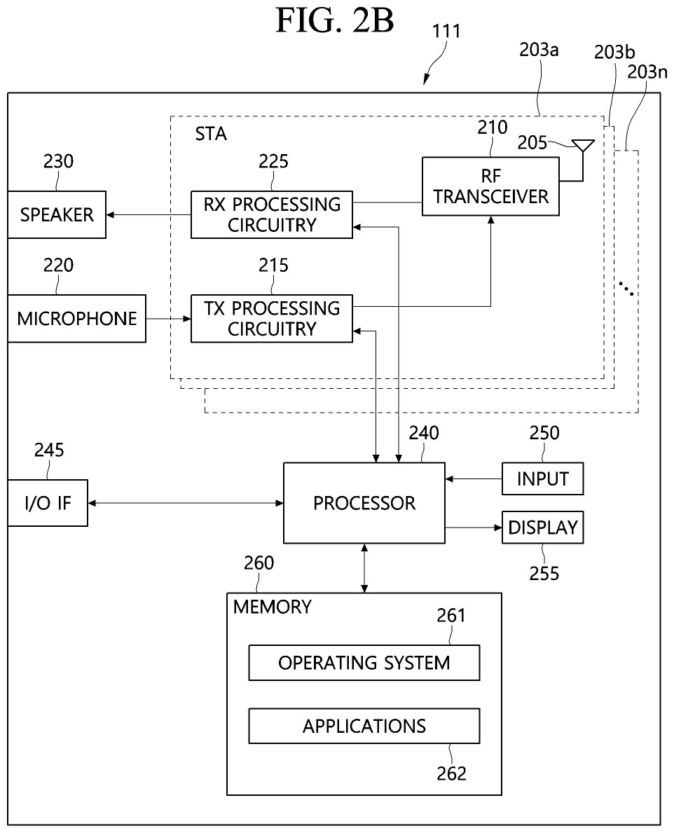

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

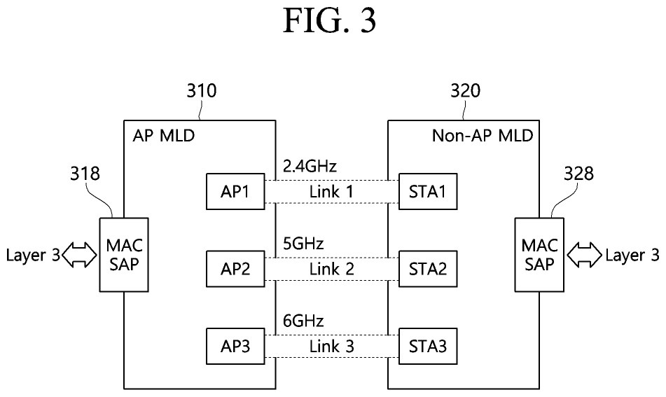

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310.

The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

As users move around an environment while holding an STA device, a signal strength of the STA to its connected AP can vary. If a user movement causes a significant decrease in a signal strength, a handover may be necessary. During the process of handover, an STA may switch from its current associated AP to a new AP.

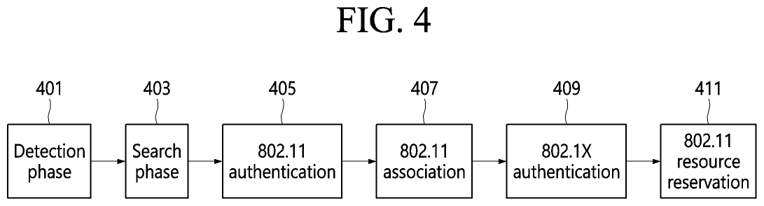

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and a 802.11 resource reservation phase 411.

During the detection phase 401, an STA may determine that there is a need for a handover. The procedures to detect a need for handover may be vendor specific. For instance, a particular vendor implementation can choose to trigger handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively, for example, by listening to beacons on a particular channel, or actively, for example, by the use of probe request and response procedure.

After the scanning procedure is complete, the next step is to perform 802.11 authentication (open system/shared key based) 405. Once the STA is authenticated, the next step is to perform 802.11 association 807. Introduced in IEEE 802.1i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures may be to remove or reduce the delay encountered in various steps of the handover procedure. In 2008, IEEE 802.11r standard introduced a fast transition roaming which may eliminate the need for the authentication step during the handover. In 2011, IEEE 802.11k introduced assisted roaming which reduces the search phase by allowing the STA to request the AP to send channel information of candidate neighbor APs. In 2011, IEEE 802.11v also introduced network assisted roaming to assist the search phase. In IEEE 802.11be, the fast BSS transition procedure was extended to cover the case of MLO operation. This procedure helps to reduce the delays encountered due to 802.11 resource reservation. However, the STA may still need to perform the association and authentication phases which can take e.g., 10s of ms.

In next generation WLANs, low-latency with high reliability support has been targeted. In order to meet this goal, the concept of a logical AP MLD can be considered.

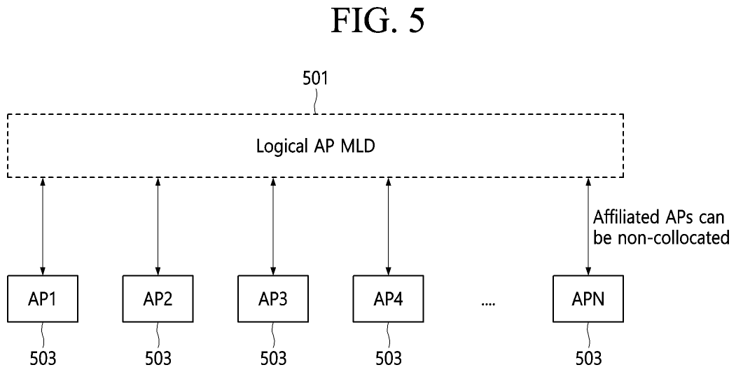

FIG. 5 illustrates a logical AP MLD in accordance with an embodiment. As illustrated in FIG. 5, a logical AP MLD 501 can be made up of several APs 503, including AP1, AP2, AP3, AP4 to APN, which can be non-collocated. This may be different from the concept of AP MLD in IEEE 802.11be which considers collocated APs affiliated with an AP MLD. Further, one or more of these APs 503 can have a common data path to a router or a central controller. The APs 503 shown in FIG. 5 can form a logical AP MLD 501. This concept of AP MLD may reduce the delays of association and authentication steps mentioned above as the STA may not need to perform association and authentication during handover.

In some embodiments, a logical AP MLD can be used for a number of purposes besides mobility management such as multi-AP coordination, relay operation, among other applications. The logical AP MLD can be any kind of AP MLD where a coordination mechanism exists between the different APs (for example, non-collocated AP MLD, Seamless Mobility Domain, among others).

In some embodiments, when an STA undergoes handover from one physical AP MLD to another physical AP MLD, a procedure may be used for the handover. As different non-collocated APs form a logical AP MLD, there can be an issue with respect to link indication. The legacy link indication procedure allows link IDs to go from 0-15 and two links of the same AP MLD cannot have the same link ID. However, as the APs are non-collocated, there can be an overlap in the link IDs that are used by different APs in the logical AP MLD. Link IDs may be used in a number of signaling processes and duplication of link IDs can cause a problem at the non-AP MLD side. Accordingly, embodiments in accordance with this disclosure may provide various procedures by which several links can be differentiated.

In some embodiments, a recommendation or preparation making entity can be an entity that makes a new link setup recommendation or preparation and the entity that receives such a recommendation or prepared information can be a recommendation or prepared information receiving entity.

In some embodiments, when a recommendation or preparation making entity makes a link setup recommendation or preparation, it can transmit a link setup recommendation or preparation message to the recommendation or prepared information receiving entity. The link setup recommendation or preparation message can include at least one or more of the information items as indicated in Table 1.

TABLE 1

| Information item | Description |
|---|---|
| New link indication | One or more information item(s) that can describe the new link(s) that |
| | is being recommended or has been prepared. E.g., link ID, link ID |
| | along with an additional identifier such as a collocated set ID, etc. This |
| | can indicate to the recommendation/prepared information receiving |
| | entity which new link(s) can be added to the current setup. |
| New STA details | One or more information item(s) that can provide details on the new |
| | STA(s) (AP/non-AP) that the recommendation receiving or prepared |
| | information entity can be communicating with if the new setup takes |
| | effect. E.g., MAC address. Another example can be that of a list of |
| | prepared candidate AP(s)/AP MLD(s) or a list of candidate AP(s)/AP |
| | MLD(s). E.g., a list of AP/AP MLD IDs such as BSSID. The details |
| | of the STA can also include information related to the domain of the |
| | APs. E.g., a roaming domain identifier. |
| Existing link | An information item that can describe an existing link(s) that can |
| indication | undergo a change. E.g., link ID, link ID along with an additional |
| | identifier such as a collocated set ID, etc. |
| Existing STA details | An information item that can provide details on the existing STA(s) |
| | (AP/non-AP) that is operating on the existing link(s) as described |
| | above. E.g., MAC address, complete STA profile, etc. |
| Action | For the link(s) indicated above, what action(s) is recommended by the |
| recommendation | recommending entity. E.g., to add the new link and/or to delete the old |
| | link. |
| Recommendation | An information item that can indicate the type of recommendation that |
| type | the recommendation making entity is making. E.g., a soft |
| | recommendation that can be ignored by the recommendation receiving |
| | entity, a hard recommendation that can be enforced by the |
| | recommendation making entity, etc. |
| Reason information | An information item that can indicate the reason for sending the above |
| | message. E.g., reason code. |
| Deadline | An information item that can indicate a deadline until which the |
| information | recommendation or preparation message can be considered as being |
| | valid. The new setup needs to take place before the deadline. E.g., the |
| | STA needs to roam to the new AP prior to the deadline. |

The above information items in Table 1 can be transmitted together or separately. They can be transmitted as a part of any existing frame/element/field/subfield in the standard or can be a part of newly defined ones.

When the recommendation or preparation making entity is the logical AP MLD or its affiliated APs, the link setup recommendation or preparation message can be transmitted via one or more of its affiliated APs. The logical AP MLD can determine the need to send a link setup recommendation or preparation message based on a number of factors such as poor signal strength on one or more of the links that are setup with a non-AP MLD, packet loss rate, among various other factors. If the recommendation or preparation receiving entity is the non-AP MLD, then the non-AP MLD can assess the feasibility or benefits of switching over to the link setup that is being recommended by the logical AP MLD. If it is feasible, the non-AP MLD can take the necessary actions to switch to the recommended setup. For example, the non-AP MLD can consider the information provided in the recommendation or preparation message for AP selection and chose one of the APs and roam to it.

In some embodiments, when the recommendation making entity is the non-AP MLD, the link setup recommendation message can be transmitted to one or more of the affiliated APs of the logical AP MLD. The non-AP MLD can determine the need to send a link setup recommendation message based on a number of factors such as poor signal strength on one or more of the links that are setup with the logical AP MLD, packet loss rate, among other factors. If the recommendation receiving entity is the logical AP MLD, then the logical AP MLD can assess the feasibility or benefits of switching the non-AP MLD to the link setup that is being recommended by the non-AP MLD. If it is feasible, then the logical AP MLD can take the necessary action to switch to the recommended setup

In some embodiments, an entity can also request for a link setup recommendation or preparation from the other entity. In some embodiments, the non-AP MLD can make a request to the logical AP MLD or one or more of its affiliated APs for a link setup recommendation or preparation.

The requesting entity can transmit a request message to the other entity and the request message can include at least one or more of the information items as indicated in Table 2.

TABLE 2

| Information | |
|---|---|
| items | Description |
| Existing link | An information item that can describe an existing link(s) that can undergo |
| indication | a change and/or the existing link setup for the non-AP MLD. E.g., link |
| | ID, link ID along with an additional identifier such as a collocated set ID, |
| | etc. |
| Existing STA | An information item that can provide details on the existing STA(s) |
| details | (AP/non-AP) that is operating on the existing link(s) as described above. |
| | E.g., MAC address, complete STA profile, etc. |
| Performance | An information item that can provide details on the performance of the |
| indicator | existing links. E.g., signal strength, delays, achievable data rate, etc. |
| Time indication | An information item that can indicate the time before which the non-AP |
| | MLD needs a recommendation. E.g., the number of Target Beacon |
| | Transition Time (TBTTs) from the current TBTT before which the |
| | recommendation can be generated, the duration, etc. |
| Reason | An information item that can indicate the reason for sending the request |
| information | message |
| New link | An information item that can describe the new link(s) that is being |
| indication | requested to be prepared. E.g., link ID, link ID along with an additional |
| | identifier such as a collocated set ID, etc. |
| New STA details | An information item that can provide details on the new STA(s) (AP/non- |
| | AP) that the recommendation or prepared information receiving entity |
| | can be communicating with if the new setup takes effect. E.g., MAC |
| | address. Another example can be that of a list of prepared candidate |
| | AP(s)/AP MLD(s) or a list of candidate AP(s)/AP MLD(s). E.g., a list of |
| | AP/AP MLD IDs such as BSSID. The details of the STA can also include |
| | information related to the domain of the APs. E.g., a roaming domain |
| | identifier. |

The above information items in Table 2 can be transmitted together or separately. They can be transmitted as a part of any existing frame/element/field/subfield in the standard or can be a part of newly defined ones. Upon receiving the above request message, the receiving entity can generate a link setup recommendation message as described herein.

In some embodiments, when the requesting entity is the non-AP MLD, the non-AP MLD can transmit a request message and wait for a response. Upon receiving the response, the non-AP MLD can consider the new set of links that are recommended to it or prepared for it and can consider to switch to one of those new links. In some embodiments, when the request receiving entity is the logical AP MLD, the logical AP MLD can determine the links that the non-AP MLD can switch over to. Upon making the determination, the logical AP MLD can generate a link setup recommendation message and transmit to the non-AP MLD.

In some embodiments, when the requesting entity is the logical AP MLD, the logical AP MLD can transmit a request message and wait for a response. Upon receiving the response, the non-AP MLD can consider the new set of links that are recommended to it and can consider to switch to one of the new set of links to communicate with the AP MLD (e.g., via an AP selection technique). In some embodiments, when the request receiving entity is the non-AP MLD, the non-AP MLD can determine the links that can be suitable for it after transition. Upon making the determination, the non-AP MLD can generate a link setup recommendation message or request message and transmit the message to the logical AP MLD.

In some embodiments, the transition requesting entity can transmit a request message that can include at least one or more of the information items as indicated in Table 3.

TABLE 3

| Information | |
|---|---|
| item | Description |
| Existing link | An information item that can describe an existing link(s) that can undergo |
| indication | a change and/or the existing link setup for the non-AP MLD. E.g., link |
| | ID, link ID along with an additional identifier such as a collocated set ID, |
| | etc. |
| Existing STA | An information item that can provide details on the existing STA(s) |
| details | (AP/non-AP) that is operating on the existing link(s). E.g., MAC address, |
| | complete STA profile, etc. |
| New link | An information item/one or more information item(s) that can describe |
| indication | the new link(s) that is being requested. E.g., link ID, link ID along with |
| | an additional identifier such as a collocated set ID, etc. This can indicate |
| | to the receiving entity which new link(s) can be added to the current |
| | setup. |
| New STA details | An information item/one or more information item(s) that can provide |
| | details on the new STA(s) (AP/non-AP) that the receiving entity can be |
| | communicating with if the new setup takes effect. E.g., MAC address. |
| | Another example can be a target AP that the non-AP wants to roam to. |
| | This can also include domain information. E.g., a roaming domain ID. |
| Timing | An information item that can indicate the time before which the transition |
| information | can occur. E.g., the number of TBTTs from the current TBTT at which |
| | the transition is being requested, time duration, etc. |
| Reason | An information item that can describe the reason information. E.g., |
| information | reason code. |
| Reference | An information item that can serve as a reference for the request message. |
| information | E.g., dialog token |

The above information items in Table 3 can be transmitted together or separately. They can be transmitted as a part of any existing frame/element/field/subfield in the standard or can be a part of newly defined ones.

In some embodiments, upon receiving the request message, the receiving entity can process the message and evaluate its feasibility or benefits. The requesting entity can generate a response message that can include at least one or more of the information items as described in Table 4.

TABLE 4

| Information | |
|---|---|
| items | Description |
| New link | An information item that can describe the new link(s) that is being |
| indication | accepted. E.g., link ID, link ID along with an additional identifier such as |
| | a collocated set ID, etc. This can indicate to the receiving entity which |
| | new link(s) can be added to the current setup. If the link(s) indicated in |
| | the request message are not feasible, the response message can contain |
| | the links that are feasible. |
| New STA details | An information item that can provide details on the new STA(s) (AP/non- |
| | AP) that the receiving entity can be communicating with if the new setup |
| | takes effect. E.g., MAC address, complete STA profile, group keys, AID, |
| | domain identifier, downlink data delivery time, etc. |
| Timing | An information item that can indicate the time before which the transition |
| information | can occur. E.g., the number of TBTTs from the current TBTT at which |
| | the transition is being requested, time duration, etc. |
| Reason | An information item that can describe the reason information. E.g., |
| information | reason code. |
| Status | An information item that can indicate the status of the request. E.g., |
| information | Status code. |
| Reference | An information item that can serve as a reference for the request message. |
| information | E.g., the same dialog token that was used in the request message. |

The information items in Table 4 can be transmitted together or separately. They can be transmitted as a part of any existing frame/element/field/subfield in the standard or can be a part of newly defined ones.

In some embodiments, when the requesting entity is the non-AP MLD, the non-AP MLD can transmit a request message and wait for a response. Upon receiving the response, the non-AP MLD can transition to the new set of links as indicated by the response message at the indicated time. When the request receiving entity is the logical AP MLD, the logical AP MLD can determine the links that the non-AP MLD can switch over to. If the link setup requested by the non-AP MLD are feasible, the logical AP MLD can indicate the same links in the response message. Otherwise, the logical AP MLD can determine a new link setup on its own and indicate those in the response message. At the indicated time, the logical AP MLD and the non-AP MLD can switch over to the new set of links

In some embodiments, upon receiving a request, the current AP can take necessary actions to ensure that the non-AP MLD can transition over to the target AP.

In some embodiments, when the requesting entity is the logical AP MLD, the logical AP MLD can transmit a request message and wait for a response. Upon receiving the response, the logical AP MLD can transition to the new set of links as indicated by the response message at the indicated time. When the request receiving entity is the non-AP MLD, the non-AP MLD can determine the links that the logical AP MLD can switch over to. If the link setup requested by the logical AP MLD are feasible, the non-AP MLD can indicate the same links in the response message. Otherwise, the non-AP MLD can determine a new link setup on its own and indicate those in the response message. At the indicated time, the logical AP MLD and the non-AP MLD can switch over to the new set of links.

In some embodiments, a transition seeking entity can also transmit an unsolicited message that can include at least one or more of the information items as indicated in Table 5.

TABLE 5

| Information | |
|---|---|
| item | Description |
| Existing link | An information item that can describe an existing link(s) that can undergo |
| indication | a change and/or the existing link setup for the non-AP MLD. E.g., link |
| | ID, link ID along with an additional identifier such as a collocated set ID, |
| | etc. |
| Existing STA | An information item that can provide details on the existing STA(s) |
| details | (AP/non-AP) that is operating on the existing link(s). E.g., MAC address |
| New link | An information item that can describe the new link(s) that is being set. |
| indication | E.g., link ID, link ID along with an additional identifier such as a |
| | collocated set ID, etc. This can indicate to the receiving entity which new |
| | link(s) can be added to the current setup. |
| New STA details | An information item that can provide details on the new STA(s) (AP/non- |
| | AP) that the receiving entity can be communicating with if the new setup |
| | takes effect. E.g., MAC address. |
| Timing | An information item that can indicate the time before which the transition |
| information | can occur. E.g., the number of TBTTs from the current TBTT at which |
| | the transition is being requested, time duration, etc. |
| Reason | An information item that can describe the reason information. E.g., |
| information | reason code. |
| Reference | An information item that can serve as a reference for the request message. |
| information | E.g., dialog token |

The above information items in Table 5 can be transmitted together or separately. They can be transmitted as a part of any existing frame/element/field/subfield in the standard or can be a part of newly defined ones.

In some embodiments, when the unsolicited message is transmitted by the logical AP MLD, the non-AP MLD can comply with it and switch to the indicated link(s) setup at the time indicated. In some embodiments, when the unsolicited message is transmitted by the non-AP MLD, the logical AP MLD can comply with it and switch to the indicated link(s) setup at the time indicated.

In some embodiments, an existing link can be deleted first prior to adding a new link. In some embodiments, a new link can be added separately. In some embodiments, if the non-AP MLD determines that the existing link does not provide good performance, the non-AP MLD can delete the link prior to adding a new link.

In some embodiments, the non-AP MLD can add a new link prior to deleting an existing link. In some embodiments, an existing link can be deleted after a new link is added. In some embodiments, if the non-AP MLD wants to evaluate various new links prior to switching to one of the new links, the non-AP MLD can still maintain one or more of its existing links while adding new links. In some embodiments, the non-AP MLD can add and delete links at the same time. In some embodiments, a transition can occur at once instead of occurring in stages.

In some embodiments, when the APs form a non-collocated AP MLD (an example of logical AP MLD where the upper MAC can be shared between different APs), the current AP of the non-collocated AP MLD, can transmit a link recommendation message to the STA. The STA can process the link recommendation and chose a target AP. Upon selection of a target AP, the STA can inform the current AP of the non-collocated AP MLD about the need for a link switch. The non-collocated AP MLD can then change the link of the STA and the STA can communicate with the target or new AP.

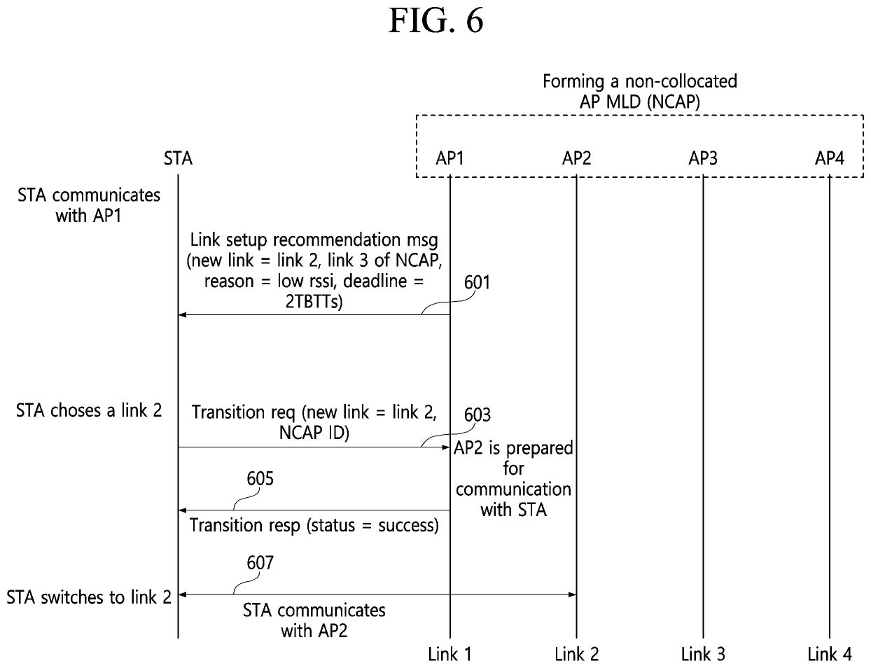

FIG. 6 illustrates forming a Non-Collocated AP MLD (NCAP) in accordance with an embodiment. In particular, FIG. 6 illustrates communication between an STA and AP1 on link 1, AP2 on link 2, AP3 on link 3, and AP4 on link 4 that form a NCAP. The APs form a Non-Collocated AP MLD. Although one or more operations are described or shown in particular sequential order, in other embodiments the operations may be rearranged in a different order, which may include performance of multiple operations in at least partially overlapping time periods. As illustrated, STA communicates with AP1.

In operation 601, the current AP (AP1) transmits to the STA, a link setup recommendation message that indicates a set of parameters including information on link recommendations, reason information, and deadline information, among various other information (new link=link 2, link 3 of NCAP, reason=low RSSI, deadline=2TBTTs). In particulate, AP1 recommends link 2 and link 3 of the NCAP, the reason for sending the message is low Received Signal Strength Indicator (RSSI), and the deadline by which the recommendation message can be considered as valid is 2 Target Beacon Transmission Times (TBTTs).

In operation 603, the STA informs the current AP (AP1) about the need for a link switch and choses link 2. In particular, STA transmits to AP1 a transition request message with parameters (new link=2, and NCAP ID). The transition request message indicates that STA choses link 2 and includes the NCAP ID. Accordingly, AP2 is prepared for communication with STA.

In operation 605, AP1 transmits to the STA a transition response message with a status indication of success (status=success). The non-collocated AP MLD can then change the link of the STA and the STA can communicate with the new target AP.

In operation 607, STA switches to link 2, and communicates with the new target AP (AP2).

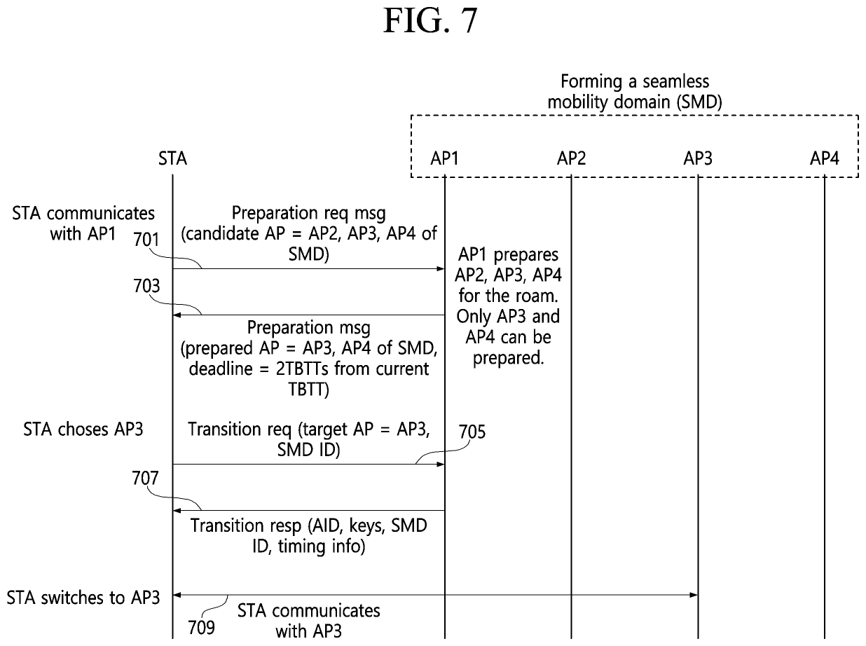

FIG. 7 illustrates an AP forming a Seamless Mobility Domain (SMD) in accordance with an embodiment. In some embodiments, SMD may be a logical AP MLD where the APs coordinate with each other so that the STA does not need to perform a (Re) association when transitioning from one AP to another. In particular, FIG. 7 illustrates communication among STA, AP1, AP2, AP3 and AP4. AP1, AP2, AP3 and AP4 form an SMD. Although one or more operations are described or shown in particular sequential order, in other embodiments the operations may be rearranged in a different order, which may include performance of multiple operations in at least partially overlapping time periods.

In operation 701, STA communicates with AP1 and transmits a preparation request message with indication of several candidate APs (candidate AP=AP2, AP3, AP4 of SMD). In some embodiments, the STA may send the preparation request message indicating the candidate APs of the SMD that it wants the current AP to prepare. As illustrated, the current AP (AP1) can prepare the candidate APs, including AP2, AP3 and AP4. In some embodiments, the current AP can transfer information related to the STA to these APs (AP2, AP3 and AP4). As indicated in this example, only AP3 and AP4 can be prepared and AP2 may not be prepared. For example, AP2 may not want the STA to roam to it or may not be able to support a performance or feature setup that is desired by the STA. The current AP (AP1) can inform the STA about the prepared APs (AP3 and AP4) and provide the STA with a deadline by which the STA needs to roam to a target AP for the preparation to remain valid.

As illustrated, in operation 703, AP1 transmits a preparation message that indicates several parameters, including the prepared APs and deadline information (prepared AP=AP3, AP4 of SMD, deadline=2 TBTTs from current TBTT). In particular, the preparation message indicates that the prepared APs are AP3 and AP4 and the deadline is 2TBTTs from current TBTT.

In some embodiments, the STA can choose an AP out of the prepared APs (AP3 in this example). As illustrated, in operation 705, the STA transmits to AP1 a transition request message which indicates the target AP and identifier information (target AP=AP3, SMD ID). In particular, the transition request message indicates that the STA chooses AP3 out of the prepared APs.

In operation 707, the current AP (AP1) transmits a response message to the STA with information about different parameters needed to communicate with the target AP (AP3), including various identifiers and timing information (AID, keys, SMD ID, timing info, among other information).

In operation 709, the STA switches to the new target AP (AP3) and communicates with AP3.

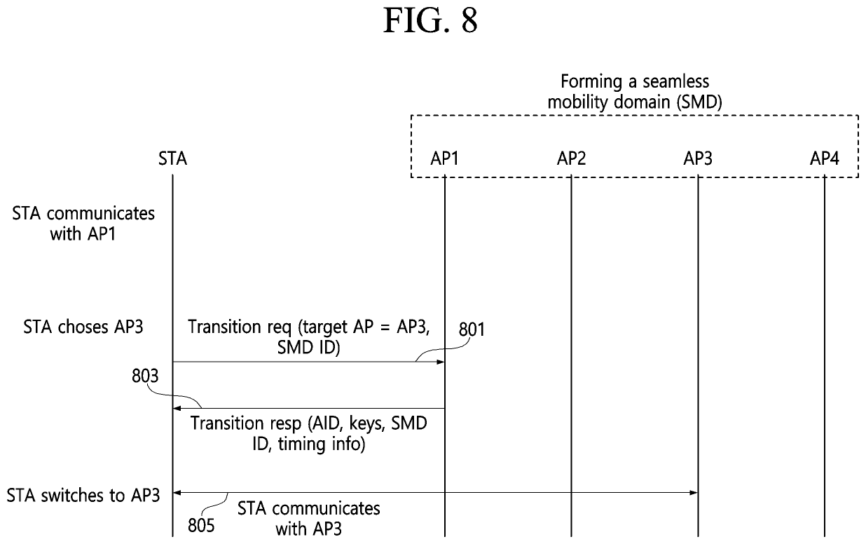

FIG. 8 illustrates an example SMD call flow without a preparation message exchange in accordance with an embodiment. In particular, FIG. 8 illustrates communication between STA 1, AP1, AP2, AP3, and AP4. AP1, AP2, AP3 and AP4 may form an SMD. Although one or more operations are described or shown in particular sequential order, in other embodiments the operations may be rearranged in a different order, which may include performance of multiple operations in at least partially overlapping time periods.

As illustrated, STA1 communicates with AP1 and STA choses AP3.

In operation 801, STA1 transmits a transition request message with information regarding the target AP and identifier information (target AP=AP3, SMD ID). In particular, the transition request message indicates the target AP be set to AP 3.

In operation 803, AP1 transmits a transition response message with various information about the target AP (AP3) including identifier, keys, and timing information (AID, keys, SMD ID, timing info).

In operation 805, STA switches to the target AP (AP3) and communicates with AP3.

In some embodiments, a STA is associated with a current AP and can intend to transition to a target AP. The current and the target AP can form a logical AP MLD as they are a part of the same enterprise network. In some embodiments, the current AP and the target AP can also be a part of the same mobility domain and can coordinate with each via the wired network.

In some embodiments, the STA may intend to transition from a current AP to the target AP. The STA can do so by transmitting a transition request message (e.g., in the form of a (Re) association request frame) to the current AP. The current AP can relay the request message to the target AP over the wired network. The target AP can process the request message and transmit a response message. The response message can be (a) transmitted to the current AP over the wired network and received by the STA via the current AP over the air and/or (b) transmitted by the target AP directly to the STA over the air.

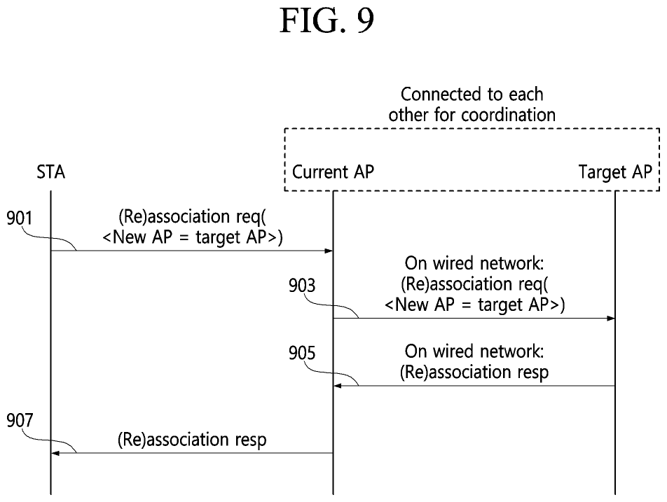

FIG. 9 illustrates an example communication of a response message via a current AP in accordance with an embodiment. In particular, FIG. 9 illustrates communication between an STA, a current AP and a target AP. Although one or more operations are described or shown in particular sequential order, in other embodiments the operations may be rearranged in a different order, which may include performance of multiple operations in at least partially overlapping time periods. The current AP and target AP may be connected to each other for coordination.

In operation 901, STA transmits to the Current AP, a (Re) association request message that indicates the STA intends to transition from the current AP to the target AP. In particular, the request message may indicate that the new AP be set to the target AP (New AP=target AP).

In operation 903, the Current AP transmits to the Target AP on the wired netowk, a (Re) association request message that indicates the new AP be set to the target AP (New AP=target AP).

In operation 905, the Target AP transmits to the Current AP on the wired network, a (Re) association response message on the wired network.

In operation 907, the Current AP transmits to the STA, a (Re) association response message.

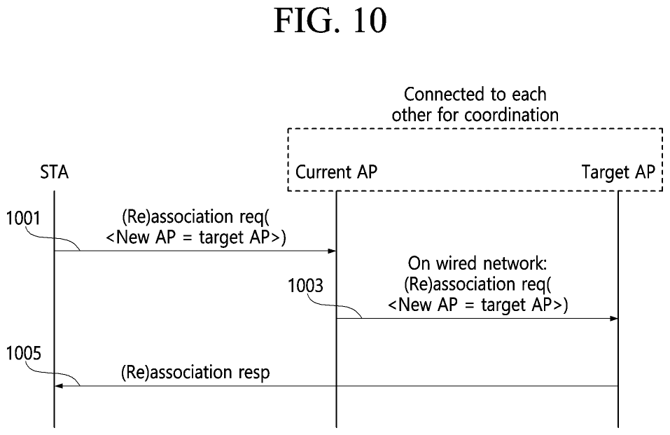

FIG. 10 illustrates an example communication of a response message via a target AP in accordance with an embodiment. Although one or more operations are described or shown in particular sequential order, in other embodiments the operations may be rearranged in a different order, which may include performance of multiple operations in at least partially overlapping time periods.

In particular, FIG. 10 illustrates communication between an STA, a Current AP and a Target AP. The Current AP and Target AP may be connected to each other for coordination.

In operation 1001, STA transmits to the Current AP a (Re) association request message that indicates the STA intends to transition from the current AP to the target AP. The request message indicates the new AP be set to the target AP (New AP=target AP).

In operation 1003, the Current AP transmits to the Target AP on the wired network, a (Re) association request message that indicates the new AP bet set to the target AP (New AP=target AP) on the wired network.

In operation 1005, the Target AP transmits to the STA, a (Re) association response message.

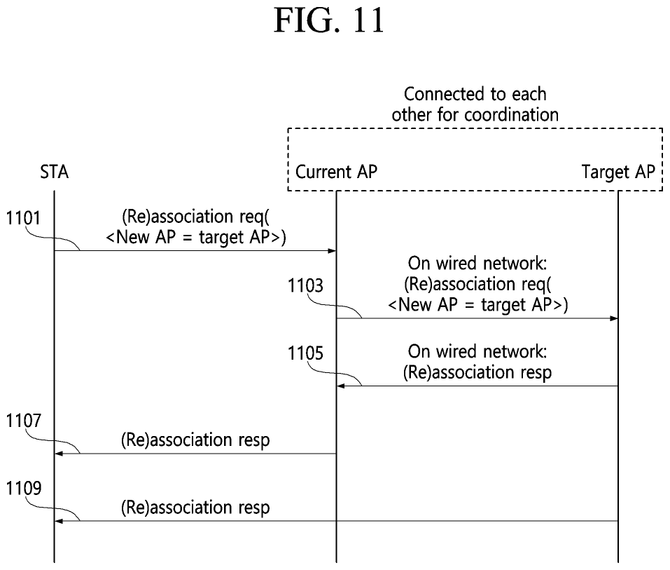

FIG. 11 illustrates an example communication on a wired network in accordance with an embodiment. Although one or more operations are described or shown in particular sequential order, in other embodiments the operations may be rearranged in a different order, which may include performance of multiple operations in at least partially overlapping time periods.

In particular, FIG. 11 illustrates communication between an STA, a Current AP and a Target AP. The Current AP and Target AP may be connected to each other for coordination.

In operation 1101, STA transmits to the Current AP, a (Re) association request message that indicates the STA intends to transition from the current AP to the target AP. In particular, the request message indicates the new AP be set to the target AP (New AP=target AP).

In operation 1103, the Current AP transmits on the wired network to the Target AP, a (Re) association request message that indicates the new AP be set to the target AP (New AP=target AP).

In operation 1105, the Target AP transmits on the wired network to the Current AP, a (Re) association response message.

In operation 1107, the Current AP transmits to the STA, a (Re) association response message.

In operation 1109, the Target AP transmits to the STA, a (Re) association response message.

In some embodiments, upon transitioning over to the new link setup, in the beginning all TIDs can be considered as mapped to all the new link(s) until a new TID to link mapping is established.

In some embodiments, the messages exchanged during transition itself can indicate the new target link mapping (TTLM) indication. Either the request and/or the response message can include the new (TTLM) indication. The procedures described herein can be applicable for single link operation as well and are not limited to multi-link operation.

In some embodiments, the term logical AP MLD can mean a kind of connection between APs that enable a coordination amongst them. In some embodiments, this can refer to non-collocated AP MLD where the APs share a common upper Media Access Control (MAC), seamless mobility domain (SMD) where AP coordinate amongst each other to allow roaming without (Re) association, mobility domains where APs can coordinate amongst each other via a controller, among other configurations.

In some embodiments, instead of using a particular number of bits (e.g., 4 bits) for link ID representation, the number of bits can be increased. In some embodiments, the number of bits used to represent a link ID can be increased such that the maximum number of links that can be supported in a non-collocated AP MLD is less than or equal the maximum number that can be indicated by the use of the increased number of bits.

In some embodiments, a number of bits can be increased by making use of reserved bits in the same frame to carry the remainder of the bits required for link ID representation.

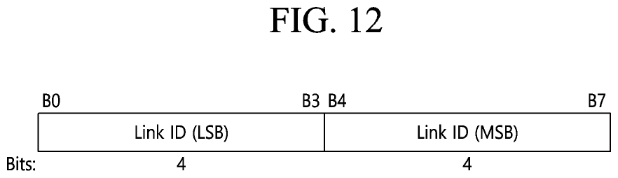

FIG. 12 illustrates an example link ID info field in accordance with an embodiment. In particular, FIG. 12 illustrates an example the link ID info field where the reserved bits in the link ID info field may be used to indicate the extra bits needed for Link ID representation in accordance with an embodiment. The link ID info field includes a Link ID Least Significant Bits (LSB) field and Link ID Most Significant Bits (MSB) field. Here the Link ID (MSB) bits field can be present if the recipient of the link ID info field can be a next generation device (e.g., 11bn). Otherwise, the 4 bits can be left unused and only the 4 lower bits of the link ID LSB field can be transmitted. In some embodiments, when a device receives the Link ID info field, the device can combine the MSB and LSB when interpreting the link ID. In some embodiments, when a legacy device receives this field, it can omit the 4 MSBs to interpret the field.

In some embodiments, an additional information item can be coupled with link ID to make the differentiation. The additional item can be one or more of the information items as indicated in Table 6.

TABLE 6

| Information | |
|---|---|
| item | Description |
| MLD | An information item that can be used to represent the MLDs that are a part |
| identifier | of the logical AP MLD. The information item can be used together with the |
| | link ID to make the differentiation. E.g., MLD MAC address, MLD ID. |
| Collocated | An information item that can be used to indicate one or more of the collocated |
| AP identifier | APs that are a part of the logical AP MLD. For instance, there can be a |
| | collocated AP identifier which can be assigned to the collocated APs that are |
| | a part of the logical AP MLD. This can be used together with the link ID to |
| | make the differentiation. |
| Any distinct | An information item that can be any of the distinct identifiers that can be |
| identifier | unique to the entity where all the collocated APs are present. |

In some embodiments, one or more of the reserved bits in frames that carry the link ID information can be used to indicate the extra information item that is used along with the link ID to make the differentiation.

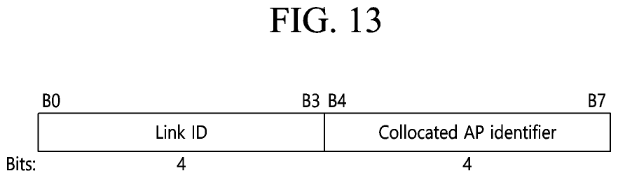

FIG. 13 illustrates a link ID info field format in accordance with an embodiment. The link ID info field includes a link ID field and a collocated AP identifier field. In some embodiments, when the link ID info field is received by a legacy device, the legacy device can interpret the signaling by using only the B0-B3 bits of the link ID info field. In some embodiments, when a next generation (e.g., 11bn) device receives the link ID info field, then it can interpret it by using both the link ID field and the collocated AP identifier field. Thus, two links of the logical AP MLD that have the same link ID can be differentiated by using the collocated AP identifier.

In some embodiments, when the non-AP MLD receives a frame that includes a link ID from an AP affiliated with an AP MLD, then the non-AP MLD can interpret that the link ID may belong to the AP MLD whose affiliated AP sent that frame. Thus, even if there are two or more links that have duplicate link IDs, the transmitting AP or AP MLD's identifier (e.g., MAC address) can be used to differentiate between the two duplicate links.

In some embodiments, a Link ID bitmap may be used to map some information to one or more links. Typically, the link ID bitmap is 1 or 2 octets in size. When the ith position of the link ID bitmap is set to 1 it may indicate that the specified information is mapped to a link with link ID equal to i. However, in logical a AP MLD, there can be links greater than the maximum number of links in legacy devices. Accordingly, embodiments in accordance with this disclosure may provide procedures to differentiate between the links.

In some embodiments, the size of the link ID bitmap can be increased. The logical AP MLD can advertise the increased size of the bitmap via one or more frames that it transmits (e.g., management frames). The devices that receive such frames (e.g., 11bn devices) can understand that the bitmap size is bigger than that used for legacy devices. These devices can then interpret the extra octets following the link ID bitmap as being a part of the bitmap. In some embodiments, the link ID bitmap size can be variable. In some embodiments, if a non-AP MLD has K links with a logical AP MLD, then a bitmap of size K can be used when communicating with that particular non-AP MLD.

In some embodiments, when a bitmap is present in signaling that is advertised via a frame that is transmitted by an AP affiliated with an AP MLD, then the bitmap can only indicate information relevant to the links of that AP MLD that are a part of the logical AP MLD. Thus, the transmitting AP or AP MLD's identifier (e.g., MAC address) can be used as a factor to understand which links' mapping is indicated by the received link ID bitmap.

In some embodiments, when a non-AP MLD associates with a logical AP MLD, then it can receive a link ID mapping info from the logical AP MLD. This link ID mapping info can indicate to the non-AP MLD how the links of the logical AP MLD map to the link IDs of the link IDs in the link ID bitmap. For example, when a non-AP MLD forms links with the logical AP MLD with link ID equal to k, 1 and m where one or more the link ID values are greater than the maximum link ID value that can be indicated via the link ID bitmap, then the link ID mapping info can indicate that k is mapped to link ID equal to 1, 1 is mapped to link ID equal to 2 and m is mapped to link ID equal to 3 in the link ID bitmap. Thus, when the non-AP MLD receives a link ID bitmap in which the bit in position 1 is set to 1, it can understand that the indication corresponds to the link with link ID equal to k.

In some embodiments, the link ID mapping info can include at least one or more of the information items as indicated in Table 7.

TABLE 7

| Information | |
|---|---|
| items | Description |
| Formed link | An information item that can indicate the link ID(s) of the link(s) that are |
| identifier | currently formed by the non-AP MLD with the logical AP MLD. E.g., |
| | either individual link IDs information or link IDs coupled with extra |
| | information items as described previously. |
| Mapped link | An information item that can indicate for each of the link identifiers(s) |
| identifier | indicated above which link ID(s) in the link ID bitmap to be received by |
| | the non-AP MLD, these link identifiers(s) can be mapped to. E.g., this can |
| | be a list of link IDs of the link ID bitmap that are arranged in the same order |
| | as the formed link identifiers. In another example, instead of a list, this can |
| | be pairs of information items where one is the formed link identifier and |
| | the other is the link ID of the link ID bitmap to which this is mapped to. |

The above information items in Table 7 can be transmitted together or separately. They can be transmitted as a part of any existing frame/element/field/subfield in the standard or can be a part of newly defined ones. In some embodiments, there can be an element that can carry the above information in Table 7.

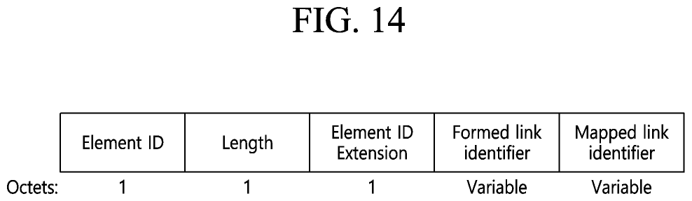

FIG. 14 illustrates an example element format in accordance with an embodiment. The element may include an element ID field, a length field, an element ID extension field, a formed link identifier field and a mapped link identifier field. The element ID field may provide identification information of the element. The length field may provide length information of the element. The element ID extension field may provide one or more extension information of the element. The formed link identifier field may provide information as indicated in Table 7. The mapped link identifier field may provide an information as indicated in Table 7.

In some embodiments, the element can be transmitted by the logical AP MLD to the non-AP MLD in one or more frames that it transmits. For example, when the non-AP MLD associates with a logical AP MLD, then it can include the element in (Re) association response frame. In some embodiments, upon receiving an element from the logical AP MLD, the non-AP MLD can then know that it needs to use the mapping to understand link ID bitmaps received in the future from the logical AP MLD

In some embodiments, the logical AP MLD can forbid the non-AP MLD from forming links whose APs are affiliated with two non-collocated AP MLDs. Thus, in frames that the non-AP MLD receives from the logical AP MLD, all the information can correspond to a collocated AP MLD and there can be no duplication of link IDs.

In some embodiments, the link ID bitmap can be paired together with another identifier such as those in Table 6. Thus, when a non-AP MLD receives a link ID bitmap it can understand the links that the information corresponds to.

Embodiments in accordance with this disclosure may perform a handover procedure for an STA to switch from one AP to a different AP without disruption in a connection, providing an improve user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
transmit, to a first access point (AP) via a first link, a first frame that requests a switch from the first AP to a second AP, wherein the first AP and the second AP form a seamless roaming domain and the first link is established between the STA and the first AP;
receive, from the first AP via the first link or the second AP via a second link, a second frame in response to the first frame that includes information for communicating with the second AP, wherein the second link is established between the STA and the second AP; and
switch to the second AP using the information for communicating with the second AP.

2. The STA of claim 1, wherein the second frame includes at least one of identifier information for the second AP or timing information that indicates a time during which the switch to the second AP is to occur.

3. The STA of claim 1, wherein the processor is further configured to:
receive, from the first AP, a frame that includes at least one of i) a recommendation that the STA switch to a different AP from one or more candidate APs that includes the second AP, ii) a reason for the recommendation, or iii) timing information that indicates a time during which the switch to the different AP is to occur.

4. The STA of claim 3, wherein the reason for the recommendation is a low quality link due to at least one of a low received signal strength indicator (RSSI) or a high packet loss rate of the STA.

5. The STA of claim 1, wherein the processor is further configured to transmit, to the first AP, a request frame that includes a first set of APs, including the second AP, that the STA prefers to switch to.

6. The STA of claim 5, wherein the processor is further configured to receive, from the first AP in response to the request frame, a response frame that includes a second set of APs, including the second AP, that are prepared for the STA to switch to.

7. The STA of claim 1, wherein the processor is further configured to:
delete the first link between the STA and the first AP in response to receiving the second frame.

8. The STA of claim 1, wherein the processor is further configured to:
maintain the first link between the STA and the first AP in response to receiving the second frame.

9. The STA of claim 1, wherein the first AP and the second AP are connected such that the first AP and the second AP coordinate with each other to allow roaming without association or reassociation with the STA.

10. A first access point (AP) in a wireless network, comprising:
a memory; and
a processor coupled to the memory, the processor configured to:
receive, from a station (STA) via a first link, a first frame that requests a switch from the first AP to a second AP, wherein the first AP and the second AP form a seamless roaming domain and the first link is established between the STA and the first AP; and
transmit, to the STA via the first link, a second frame in response to the first frame that includes information for communicating with the second AP, wherein the second link is established between the STA and the second AP.

11. The first AP of claim 10, wherein the second frame includes at least one of identifier information for the second AP or timing information that indicates a time during which the switch to the second AP is to occur.

12. The first AP of claim 10, wherein the processor is further configured to:
transmit, to the STA, a frame that includes at least one of i) a recommendation that the STA switch to a different AP from one or more candidate APs that includes the second AP, ii) a reason for the recommendation, or iii) timing information that indicates a time during which the switch to the different AP is to occur.

13. The first AP of claim 12, wherein the reason for the recommendation is a low quality link due to at least one of a low received signal strength indicator (RSSI) or a packet loss rate of the STA.

14. The first AP of claim 10, wherein the processor is further configured to receive, from the STA, a request frame that includes a first set of APs, including the second AP, that the STA prefers to switch to.

15. The first AP of claim 14, wherein the processor is further configured to transmit, to the STA in response to the request frame, a response frame that includes a second set of APs, including the second AP, that are prepared for the STA to switch to.

16. The first AP of claim 10, wherein the processor is further configured to:
delete the first link between the STA and the first AP after transmitting the second frame.

17. The first AP of claim 10, wherein the processor is further configured to:
maintain the first link between the STA and the first AP after transmitting the second frame.

18. The STA of claim 10, wherein the first AP and the second AP are connected such that the first AP and the second AP coordinate with each other to allow roaming without association or reassociation with the STA.

19. A computer-implemented method for communication by a station (STA) in a wireless network, comprising:
transmitting, to a first access point (AP) via a first link, a first frame that requests a switch from the first AP to a second AP, wherein the first AP and the second AP form a seamless roaming domain and the first link is established between the STA and the first AP;
receiving, from the first AP via the first link or the second AP via a second link, a second frame in response to the first frame that includes information for communicating with the second AP, wherein the second link is established between the STA and the second AP; and
switching to the second AP using the information for communicating with the second AP.

20. The computer-implemented method of claim 19, wherein the second frame includes at least one of identifier information for the second AP or timing information that indicates a time during which the switch to the second AP is to occur.
